(19) United States
(12) Patent Application Publication
(10) Pub. No.: US 2005/0062945 A1
(43) Pub. Date: Mar. 24, 2005

(54) Projection device with wireless devices

(76) Inventor: Huang Shin-Pin, Taipei (TW)

Correspondence Address: Raymond Y. Chan, Suite 128, 108 N. Ynez Ave., Monterey Park, CA, 91754, US

(21) Appl. No.: 10/979,560

(22) Filed: Nov. 1, 2004

Related U.S. Application Data
(62) Division of application No. 10/661,022, filed on Sep. 12, 2003.

(30) Foreign Application Priority Data
Sep. 13, 2002 (TW) 091214526

(51) Int. Cl. G03B 21/28

(52) U.S. Cl. 353/122

(57) ABSTRACT

A projection device with wireless devices is provided. The projection device with wireless devices includes a video camera for providing a camera signal a wireless transmitter electrically connected to the video camera for receiving the camera signal and transmitting the camera signal by means of a wireless transmission technology; a wireless receiver for receiving the camera signal and transforming the camera signal into a projection signal; and a projector electrically connected to the receiver for receiving the projection signal and projecting an image in response to the projection signal.

### CROSS REFERENCE OF RELATED APPLICATION

This is a divisional application of a non-provisional application, application Ser. No. 10/661,022 filed on Sep. 12, 2003, which claimed the priority of a patent application in Taiwan with application number 91214526 filed Sep. 13, 2002.

### BACKGROUND OF THE PRESENT INVENTION

1. Field of Invention

The present invention is related to a projection device, and more particularly, to a projection device with wireless devices.

2. Description of Related Arts

As the computer is available to all, the peripheral devices are more and more popular. One of them is the projector. The common basic requests for a projector are portability, light-weight, and usage convenience. Nowadays, the projector is developed in the direction with compact size, light-weight, and high quality.

The direct projector can project objects directly. Since there is no need to make transparencies, it largely reduces time to prepare a presentation. All you can see can be projected through the direct projector clearly and without losing the fidelity of the objects.

When the direct projector projects the image of the object, it needs not convert the image first and is able to project the image onto a wall directly. The steps of direct projecting are: catching the image of objects via a particular CCD (charged-coupled device) camera; converting analog signals into digital signals via LSI (Large-Scale Integration); and providing digital signals to the projector, so as to finish the projecting process.

Presently, there are two kinds of direct projection devices which are classified by size: the fixed projector and the portable projector. The advantage of the fixed projector is the highly powerful function, which can project the real images of the objects, films, and transparencies onto a wall. It has the function of electrical focusing and can enlarge image with steplessly adjustable value. It also has multi-signal input/output, so that it can be used as a central controller. However, the disadvantages of the fixed projector are bulky size and heavy weight. Besides, it also needs additional data input devices to be the data sources when using. And a fixed projector with high quality usually has a higher price. On the other hand, the advantages of the portable projector are the light-weight feature, and the data input device is built in with. With the exception that the portable projector can't project films and transparencies, the other functions of that can entirely compare with the functions of a professional projector.

Unfortunately, in the foregoing direct projectors, the CCD camera has to be held on an arm member with a predetermined distance apart from the material on the table to ensure a required shooting distance. The CCD camera is electrically connected to the projector by a wire or is built in the projector directly. Because the position and the angle of the CCD camera are restricted, which will limit the application of the projector.

From the above description, it is known that the conventional direct projector is not very practical when the user needs to adjust the position and the angle of CCD camera. What is needed is an apparatus that is designed for projecting documents or images, which allows the documents or images to be easily transmitted by radio signals, and which can project objects without the limitation for the position and location of the CCD camera.

### SUMMARY OF THE PRESENT INVENTION

It is the main object of the present invention to provide a projection device with wireless devices.

It is another object of the present invention to provide a projection device which is able to receive a radio signal and transmit a radio signal so as to project the images onto a wall.

It is another object of the present invention to provide a projection device which allows the CCD camera to be located at a remote location apart from the projector.

It is another object of the present invention to provide a projection device without any external wires which connects the CCD camera with the projector so as to avoid the troublesome wire arrangement.

According to one aspect of the present invention, the projection device includes a video camera for providing a camera signal; a wireless transmitter electrically connected to the video camera for receiving said camera signal and transmitting the camera signal by means of a wireless transmission technology; a wireless receiver for receiving the camera signal and transforming the camera signal into a projection signal; and a projector electrically connected to the receiver for receiving the projection signal and projecting an image in response to the projection signal.

Preferably, the camera signal includes an audio signal and a video signal.

Certainly, the wireless transmission technology can be a radio frequency technology.

Certainly, the wireless transmission technology can be a wireless local area network technology.

Certainly, the wireless transmission technology can be a Bluetooth technology.

Certainly, the wireless transmission technology can be an infrared technology.

According to another aspect of the present invention, the projection device includes a wireless receiver for receiving a radio signal and transforming the radio signal into a projection signal; and a projector electrically connected to the wireless receiver for projecting an image according to the projection signal.

Preferably, the camera signal includes an audio signal and a video signal.

Preferably, the radio signal is provided by a video camera.

Preferably, the video camera further comprises a wireless transmitter.

Preferably, the video camera electrically connects thereto a wireless transmitter for transmitting said radio signal through a wireless transmission technology.

Certainly, the wireless transmission technology can be a radio frequency technology.

Certainly, the wireless transmission technology can be a wireless local area network technology.

Certainly, the wireless transmission technology can be a Bluetooth technology.

Certainly, the wireless transmission technology can be an infrared technology.

The foregoing and other features and advantages of the present invention will be more clearly understood through the following descriptions with reference to the drawings, wherein:

These and other objectives, features, and advantages of the present invention will become apparent from the following detailed description, the accompanying drawings, and the appended claims.

### BRIEF DESCRIPTION OF THE DRAWINGS

FIG. 1 illustrates a projection device with wireless devices according to a preferred embodiment of the present invention.

FIG. 2 illustrates a projection device with wireless devices according to another preferred embodiment of the present invention.

FIG. 3 illustrates a projection device with wireless devices connected with a computer according to another preferred embodiment of the present invention.

FIG. 4 illustrates a projection device with wireless devices according to another preferred embodiment of the present invention.

FIG. 5 illustrates a projection device with wireless devices connected with a computer according to another preferred embodiment of the present invention.

### DETAILED DESCRIPTION OF THE PREFERRED EMBODIMENT

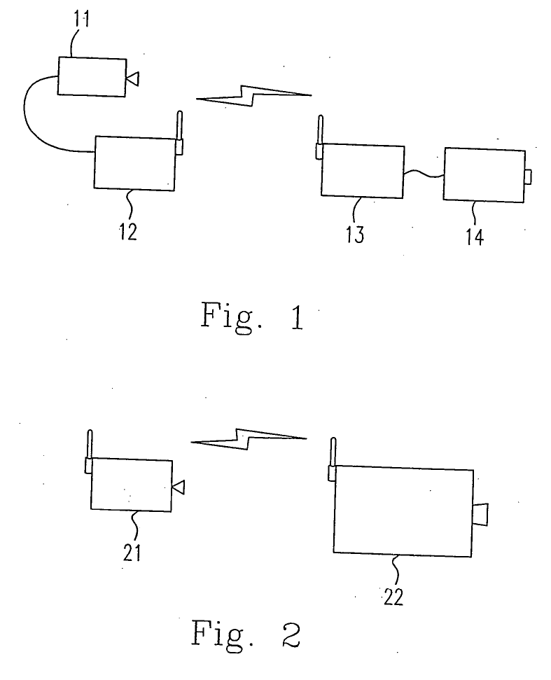

The present invention will now be described more specifically with reference to the following embodiment. Please refer to FIG. 1. FIG. 1 illustrates a projection device with wireless devices according to a first preferred embodiment of the present invention. The projection device includes a video camera 11, a wireless transmitter 12, a wireless receiver 13 and a projector 14. The wireless transmitter 12 is electrically connected to the video camera 11. The projector 14 is electrically connected to the receiver 13. The wireless transmission technology used in the wireless transmitter/receiver of the present invention is primarily based on the wireless local area network (WLAN), Bluetooth, and infrared (IrDA).

Accordingly, the video camera 11 shoots the projected object first and provides a camera signal to the wireless transmitter 12. The wireless transmitter 12 receives the camera signal and transmits the camera signal by means of a wireless transmission technology. Then, the wireless receiver 13 receives the camera signal and transforms the camera signal into a projection signal, which is then transmitted to the projector 14. Finally, the projector 14 receives the projection signal and projects the image in response to the projection signal. Thus, a projecting process is completed.

Please refer to FIG. 2. FIG. 2 illustrates a projection device with wireless devices according to a second preferred embodiment of the present invention. The projection device includes a video camera 21 and a projector 22. Meanwhile, the video camera 21 has a built-in wireless transmitter for providing a camera signal by means of a wireless transmission technology. The wireless receiver is built in the projector 22 for receiving the camera signal and transforming the camera signal into a projection signal. Therefore, the projector 22 receives the projection signal and projects the image in response to the projection signal. In such a way, the projection device is simplified.

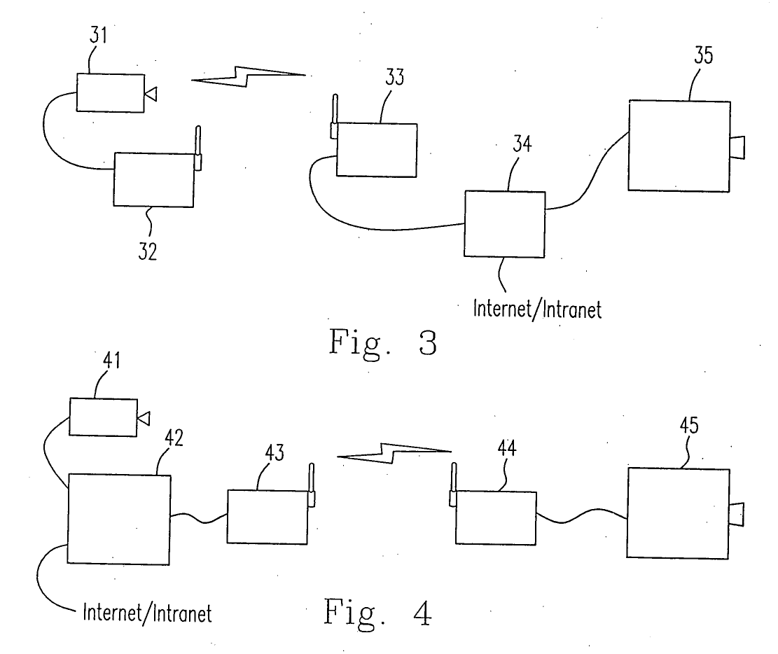

Please refer to FIG. 3. FIG. 3 illustrates a projection device with wireless devices according to a third preferred embodiment of the present invention. As shown in FIG. 3, the projection device of the present invention can be applied to a video conference. The projection device includes a video camera 31, a wireless transmitter 32, a wireless receiver 33, a computer 34 and a projector 35. The wireless transmitter 32 is electrically connected to the video camera 31. The computer 34 is electrically connected to the wireless receiver 33 and the internet/intranet.

Similarly, the video camera 31 shoots the projected object first and provides a camera signal to the wireless transmitter 32. The wireless transmitter 32 receives the camera signal and transmits the camera signal to the wireless receiver 33. When the wireless receiver 33 receives the camera signal, it will transform the camera signal into a computer signal and then transmit the computer signal to the computer 34. After the computer signal is processed by a video conference software, the computer 34 will output a projection signal to the projector 35. The projector 35 then projects the image onto a wall in response to the projection signal. In such a way, the images can be transmitted through the internet/intranet by the software before projected.

Please refer to FIG. 4. FIG. 4 illustrates a projection device with wireless devices according to a forth preferred embodiment of the present invention. The projection device includes a video camera 41, a computer 42, a wireless transmitter 43, a wireless receiver 44 and a projector 45. The computer 42 is electrically connected to the video camera 41 and the internet/intranet. The wireless transmitter 43 is electrically connected to the computer 42. The projector 45 is electrically connected to the receiver 44.

Similarly, the video camera 41 shoots the projected object first and provides a camera signal to the computer 42. After the camera signal is processed by a video conference software, the computer outputs a computer signal to the wireless transmitter 43. The wireless transmitter 43 receives the computer signal and transmits the computer signal by means of a wireless transmission technology to the projector 45 via the wireless receiver 44. The projector 45 receives the projection signal and projects an image onto a wall in response to the projection signal.

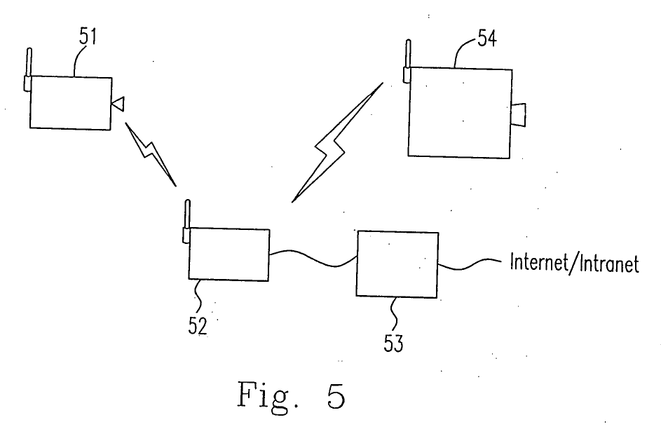

Please refer to FIG. 5. FIG. 5 illustrates a projection device with wireless devices according to a fifth preferred embodiment of the present invention. The projection device includes a video camera 51, a wireless transmitter/receiver 52, a computer 53, and a projector 54. The video camera 51 has a built-in wireless transmitter for providing a camera signal by means of a wireless transmission technology. The wireless transmitter/receiver 52 is electrically connected to the computer 53. And the computer 53 is connected to the internet/intranet.

Accordingly, after the projected object is shot, the video camera 51 provides a camera signal to the wireless transmitter/receiver 52 by means of a wireless transmission technology. The wireless transmitter/receiver 52 receives the camera signal and transforms the camera signal into a computer signal. Then, the computer 53 receives the computer signal which is then processed by a video conference software, so that the computer 53 outputs a projection signal to the wireless transmitter/receiver 52 again. Then, the wireless transmitter/receiver 52 transmits the projection signal to the projector 54 by means of a wireless transmission technology. Finally, the projector 54 receives the projection signal and projects an image on to a wall in response to the projection signal. Therefore, since the transmitter/receiver 52 is connected to the computer 53 that is connected to the internet/intranet, the projection device can certainly be used for video conference when a meeting needs to be held between two business locations.

According to the above, the projection device with wireless devices provided in the present invention includes wireless receiver and transmitter, which can receive and transmit radio signals. Therefore, the positions and angles of both video camera and projector won't be limited anymore. Besides, it doesn't need a signal line to connect the projection device with a signal source. The projection device provided in this invention is very attractive and practical for a lecturer. In addition, there is no need to run wires under carpets or through walls. The lecturer needs not worry about arranging the signal wire on the table or floor every time they come into the conference room. Wireless networking provides connectivity without the hassle and cost of wiring. Even if the business location moves, the network is ready for use as soon as the projector is moved.

In one embodiment, the projection device comprises a video camera providing a camera signal, a computer which is electrically connected to the video camera to process the camera signal from the video camera by a video conference software to form a computer signal, a wireless transmitter, which is electrically connected to the computer, receiving the computer signal outputted from the computer and transmitting the computer signal by means of a wireless transmission technology, a wireless receiver receiving the computer signal transmitted from the wireless transmitter, transforming the computer signal into a projection signal; and a projector electrically connected to the wireless receiver, wherein the projection signal is transmitted from the wireless receiver to the projector and the projector projects an image in response to the projection signal.

The computer connects with a communication network selected from internet and intranet. The wireless transmission technology is selected from a radio frequency technology, a wireless local area network technology, a Bluetooth technology, and an infrared technology.

In another embodiment, the projection device comprises a video camera providing a camera signal, a wireless transmitter built-in the video camera to transmit the camera signal by means of a first wireless transmission technology, a wireless transmitter/receiver receiving the camera signal from the wireless transmitter in the video camera and transforming the camera signal into a computer signal, a computer which is electrically connected to the wireless transmitter/receiver receiving the camera signal and processing the computer signal by a video conference software to form a projection signal which is outputted from the wireless transmitter/receiver; and a projector receiving the projection signal transmitted from the wireless transmitter/receiver by means of a second wireless transmission technology, wherein the projector projects an image in response to the projection signal.

The present invention also includes a projection method comprising the steps of:
(a) providing a camera signal by a video camera;
(b) processing the camera signal from the video camera by a video conference software to form a computer signal by a computer which is electrically connected to the video camera;
(c) receiving the computer signal outputted from the computer and transmitting the computer signal by means of a wireless transmission technology by a wireless transmitter which is electrically connected to the computer;
(d) receiving the computer signal transmitted from the wireless transmitter and transforming the computer signal into a projection signal by a wireless receiver;
(e) transmitting the projection signal to a projector which is electrically connected to the wireless receiver; and
(f) projecting an image in response to the projection signal by the projector.

The wireless transmission technology is selected from a group consisting of a radio frequency technology, a wireless local area network technology, a Bluetooth technology, and an infrared technology.

In another embodiment, the projection method comprises the steps of:
(a) providing a camera signal by a video camera;
(b) transmitting the camera signal by means of a first wireless transmission technology by a wireless transmitter;
(c) receiving the camera signal from the wireless transmitter and transforming the camera signal into a computer signal by a wireless transmitter/receiver;
(d) receiving the camera signal and processing the computer signal by a video conference software to a projection signal by a computer which is electrically connected to the wireless transmitter/receiver;
(e) outputting the projection signal from the wireless transmitter/receiver;
(f) receiving the projection signal transmitted from the wireless transmitter/receiver by means of a second wireless transmission technology by the projector; and
(g) projecting an image in response to the projection signal by the projector.

Each of the first and second wireless transmission technologies is selected from a radio frequency technology, a wireless local area network technology, a Bluetooth technology, and an infrared technology.

In anther embodiment, the projection device comprises a video camera providing a camera signal; a wireless transmitter, which is electrically connected to the video camera, receiving the camera signal from the video camera and transmitting the camera signal by means of a wireless transmission technology; a wireless receiver receiving the camera signal transmitted from the wireless transmitter, transforming the camera signal into a projection signal; a projector electrically connected to the wireless receiver, wherein the projection signal is transmitted from the wireless receiver to the projector and the projector projects an image in response to the projection signal; and a computer electrically connected to the wireless receiver and the projector, wherein after the wireless receiver receives the camera signal, the wireless receiver transforms the camera signal into a computer signal and then transmits the computer signal to the computer to process the computer signal by a video conference software to form the projection signal and output the projection signal to the projector.

The computer connects with a communication network selected from internet and intranet. The camera signal includes an audio signal and a video signal. The wireless transmission technology is selected from a radio frequency technology, a wireless local area network technology, a Bluetooth technology, and an infrared technology.

In another embodiment, the projection method comprises the steps of:
(a) providing a camera signal by a video camera;
(b) receiving the camera signal from the video camera and transmitting the camera signal by means of a wireless transmission technology by a wireless transmitter which electrically connected to the video camera;
(c) receiving the camera signal transmitted from the wireless transmitter by a wireless receiver and transforming the camera signal into a projection signal by the wireless receiver, wherein the step (c) further comprises the steps of:
(c-1) receiving the camera signal by the wireless receiver;
(c-2) transforming the camera signal into a computer signal;
(c-3) transmitting the computer signal to a computer which is electrically connected to the wireless receiver; and
(c-4) processing the computer signal by a video conference software to form the projection signal;
(d) transmitting the projection signal to a projector which is electrically connected to the wireless receiver; and
(e) projecting an image in response to the projection signal by the projector.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation, so as to encompass all such modifications and similar structures. According, the invention is not limited by the disclosure, but instead its scope is to be determined entirely by reference to the following claims.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure form such principles. Therefore, this invention includes all modifications encompassed within the spirit and scope of the following claims.

1. A projection device, comprising:
a video camera providing a camera signal;
a wireless transmitter, which is electrically connected to said video camera, receiving said camera signal from video camera and transmitting said camera signal by means of a wireless transmission technology;
a wireless receiver receiving said camera signal transmitted from said wireless transmitter, transforming said computer signal into a projection signal; and
a projector electrically connected to said wireless receiver, wherein said projection signal is transmitted from said wireless receiver to said projector and said projector projects an image in response to said projection signal.

2. The projection device, as recited in claim 1, wherein said wireless transmitter is built in said video camera.

3. The projection device, as recited in claim 1, wherein said wireless transmitter is built in said projector.

4. The projection device, as recited in claim 1, wherein said camera signal includes an audio signal and a video signal.

5. The projection device, as recited in claim 1, wherein said wireless transmission technology is selected from a group consisting of a radio frequency technology, a wireless local area network technology, a Bluetooth technology, and an infrared technology.

6. The projection device, as recited in claim 1, further comprising a computer electrically connected to said wireless receiver and said projector, wherein after said wireless receiver receives said camera signal, said wireless receiver transforms said camea signal into a computer signal and then transmits said computer signal to said computer to process said computer signal by a video conference software to form said projection signal and output said projection signal to said projector, wherein said wireless transmission technology is selected from a group consisting of a radio frequency technology, a wireless local area network technology, a Bluetooth technology, and an infrared technology.
